(19) United States
(12) Patent Application Publication
(10) Pub. No.: US 2004/0188948 A1
(43) Pub. Date: Sep. 30, 2004

(54) Molded piston seal and method of producing the same

(76) Inventor: Brian Lang, Roanoke, VA (US)

Correspondence Address: Daniel H. Shulman, Mayer, Brown, Rowe & Maw, P.O. Box 2828, Chicago, IL, 60690-2828, US

(21) Appl. No.: 10/397,581

(22) Filed: Mar. 26, 2003

(51) Int. Cl. F16J 9/20

(52) U.S. Cl. 277/436

(57) ABSTRACT

A piston seal comprising a piston seal insert having a top side, a bottom side, an outer substantially circular periphery and a central opening defined by an inner substantially circular periphery; an elastomer molded without adhesive over at least the inner periphery or the outer periphery; and wherein the molded elastomer comprises a lip portion extending upwardly and radially away from the piston seal insert.

### BACKGROUND OF THE INVENTION

1. Field of the Invention

The present invention relates to a molded piston seal and method of producing the same. Particularly, the present invention is directed to a piston seal wherein an elastomer is compression molded to a piston seal insert without adhesive between the insert and the elastomer.

2. Description of Related Art

A variety of methods and systems products are known for providing a piston seal. Such piston seals are typically used in motor vehicles in connection with an automatic transmission, brake or differential lock system. Typically, the piston seal comprises a donut-shaped metal casting having grooves machined adjacent its inner circumference and outer circumference. Rubber seals are then hand-installed into those grooves, and the piston is installed into the transmission. This design suffers from many disadvantages. The production is labor-intensive. Another disadvantage of the design is that the cast piston having two separate rubber lips is more expensive to consumers than a bonded piston seal. In addition, the rubber seals are often mistakenly installed upside down and/or can come loose during installation, making the piston seal ineffective and potentially causing failure of the transmission (or other) system. Furthermore, Accordingly, in these “cast” pistons, the gap between the wall of the transmission shaft or bore and the heel of the casting is small to prevent a loose seal from extruding through it when pressurized.

One solution to the problems posed by the above piston has been to cover a metal stamping with an adhesive and to mold the rubber seal over the adhesive on the metal stamping. Such piston seals are termed “bonded piston seals” because the rubber is adhesively bonded to the metal stamping. The gap between the wall of the transmission shaft or bore and the heel of the stamping is comparatively large because, it was heretofore believed, a wide gap was necessary to permit adequate rubber flow around the stamping during molding. This process is more efficient and less expensive than the “cast” piston and seal combination.

Bonded piston seals suffer from disadvantages as well. Specifically, the rubber molding must be heated to cure the rubber. The metal stamping at the center of the piston seal, however, acts as a heat sink and absorbs significant heat during the curing process. In turn, even more heat is needed to cure the rubber. A reduction in the molding cycle time can be accomplished by pre-heating the stamping, but this approach risks overheating the adhesive, leaving a piston seal that is inadequately bonded and more prone to failure.

A need exists in the art, therefore, for a piston seal that can be inexpensively produced but is still reliable.

### SUMMARY OF THE INVENTION

The purpose and advantages of embodiments of the present invention will be set forth in and apparent from the description that follows, as well as will be learned by practice of the invention. Additional advantages of the invention and its several embodiments will be realized and attained by the methods and systems particularly pointed out in the written description and claims hereof, as well as from the appended drawings.

An embodiment of the invention includes a piston seal comprising: a piston seal insert having a top side, a bottom side, and an outer substantially circular periphery; an elastomer molded without adhesive over the outer periphery; and wherein the molded elastomer comprises an outer lip portion extending upwardly and radially away from the insert. In alternative embodiments, the insert further comprises a central opening having aninner substantially circular periphery. In some embodiments, an elastomer may be molded around either the inner periphery, outer periphery, or both. In a preferred embodiment, piston seal is placed in a bore having a shaft therein with the shaft through the central opening in the piston seal insert.

The advances of the present invention are seen in certain embodiments that permit a thinner layer of elastomer to be used over the periphery of the insert than had been thought possible in the prior art. For example, in some embodiments, the thickness of the elastomer over the outer periphery is less than about 0.5 mm. In yet further embodiments, the thickness of the elastomer over the outer periphery is about 0.3 mm. In certain other embodiments, the distance between the bore and an outer edge of the elastomer molded over the outer periphery is less than about 0.25 mm. In yet further embodiments, the distance between the bore and an outer edge of the elastomer molded over the outer periphery is about 0.11 mm.

According to further embodiments, the elastomer is molded to the insert by compression molding. In alternative embodiments, the elastomer is molded through injection molding or transfer molding.

Other embodiments of the invention include a method for producing a piston seal comprising: heating a piston seal insert, the insert having a top side, a bottom side, and an outer substantially circular periphery; placing the heated insert in a mold; adding an elastomer to the mold to cover the outer periphery of the insert; and molding the elastomer around the outer periphery of the insert, wherein the elastomer is molded to the insert without adhesive. In other embodiments, the method further comprises spreading the insert within the elastomer, for example, through the use of coining rings. In further embodiments, the insert may have a central opening therein defined by an inner substantially circular periphery. In such embodiment, the elastomer may be molded over the inner periphery, outer periphery or both, depending on which sealing surface is required.

It is to be understood that both the foregoing general description and the following detailed description are exemplary and are intended to provide further explanation of the invention claimed.

The accompanying drawings, which are incorporated in and constitute part of this specification, are included to illustrate and provide a further understanding of the methods and embodiments of the invention. Together with the description, the drawings serve to explain the principles of the invention.

### BRIEF DESCRIPTION OF THE DRAWINGS

FIG. 1 is a cross section of a piston seal in accordance with an embodiment of the invention.

FIG. 2 is an enlarged cross sectional view of a portion of a piston seal in accordance with an embodiment of the present invention.

### DETAILED DESCRIPTION OF THE PREFERRED EMBODIMENT

Reference will now be made in detail to the present preferred embodiments of the invention, an example of which is illustrated in the accompanying drawing. The method and corresponding steps of the invention will be described in conjunction with the detailed description.

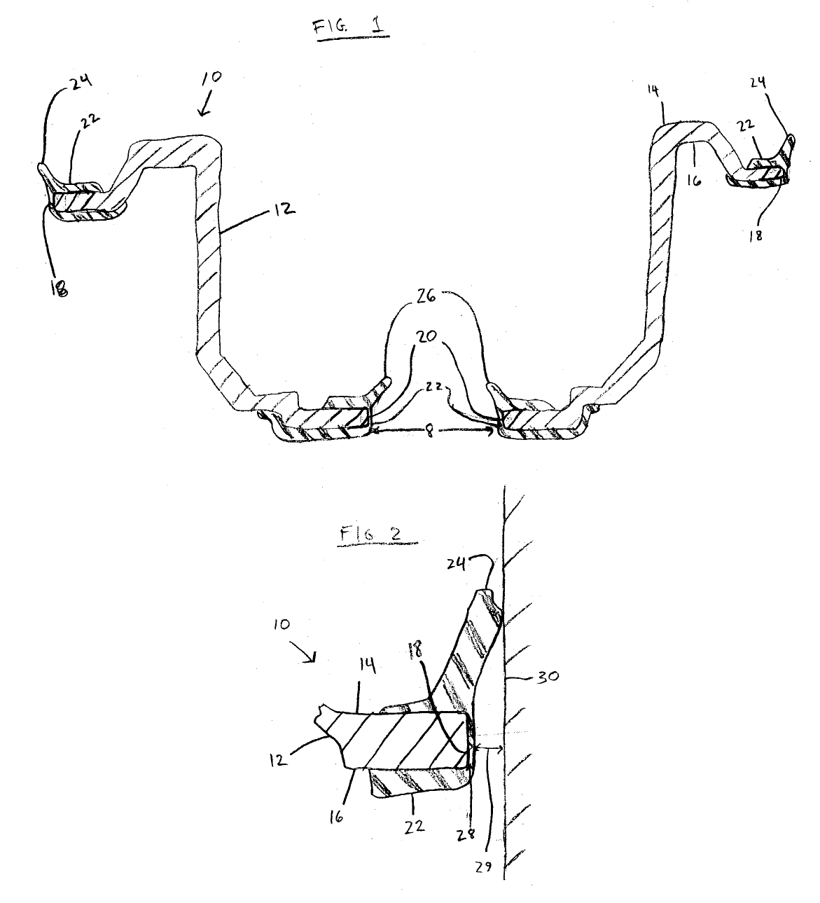

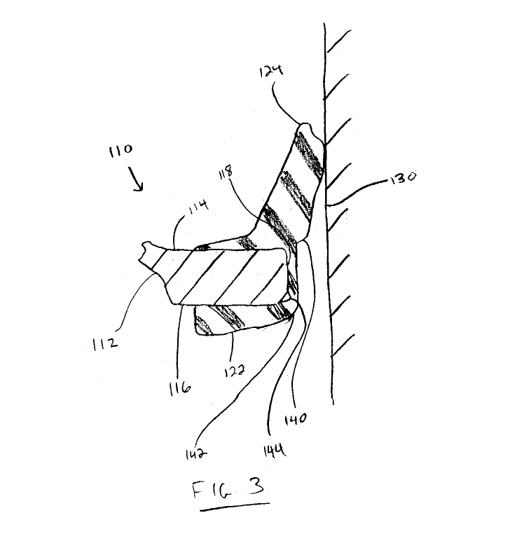

For purpose of explanation and illustration, and not limitation, an exemplary embodiment of a piston seal in accordance with the invention is shown in FIG. 1 and FIG. 2 and is designated generally by reference character 10. The piston seal 10 is designed for use in a variety of motor vehicle systems, including without limitation, automatic transmission systems, differential locks and brake systems. According to those systems, a generally circular piston system is provided comprising an outer bore and an inner shaft. Operation of the system creates a pressure differential across the piston seal with high fluid pressure above and lower fluid pressure below the seal. A proper seal is critical to maintaining fluid pressure in the system. According to the needs of the system, the piston seal is often outfitted with a valve system to manipulate pressure on one side or the other of the seal to, for example, cause an automatic transmission system to change gears.

According to the present embodiment, the piston seal 10 is generally donut-shaped when viewed from above and comprises a metal member 12 having a top side 14, a bottom side 16, an outer substantially circular periphery 18, and an inner substantially circular periphery 20 defining a central opening 8. The piston seal may alternatively be made of plastic or other material suitable to the particular environment. The piston seal insert should be thin and strong. In most embodiments, the insert will comprise steel because the oils and fluids in the automotive transmission environment provide adequate rust-proofing protection. In some embodiments, stainless steel may be used. In typical embodiments, the metal member 12 is approximately one to three mm thick, although the present invention is suitable for use with piston seals having any thickness. When the piston seal 10 is placed in the piston bore, the shaft of the piston slips through the opening 8 and abuts the piston seal 10 proximate the inner periphery 20, while the walls 30 of the bore of the piston system abut the piston seal 10 proximate the outer periphery 18.

The piston seal 10 further comprises an elastomer 22 molded without adhesive over at least the inner periphery 20 of the metal member 12 or the outer periphery 18 of the metal member 12. Attachment of the elastomer 22 to the metal member 12 without adhesive is achieved through the process described in detail below. The elastomer 22 typically comprises a material such as a synthetic fluorocarbon elastomer, ethylene acrylic, other synthetic elastomers, natural rubber or blends. In the preferred embodiment, the elastomer 12 is molded over the respective peripheries so that the elastomer 22 extends radially inward above the top side 14 and the bottom side 16 of the metal member 12 at the outer periphery 18, and radially outward above the top side 14 and bottom side 16 of the metal member 12 at the inner periphery 20. The degree to which the elastomer 22 extends over the peripheries of the metal member 12 are dependent on the needs of the particular design, the properties of the elastomer and the properties of the metal member 12. In the preferred embodiment, the elastomer 22 extends over the top side 14 approximately four mm at the outer periphery 18 and four mm at the inner periphery 20, and extends over the bottom side four mm over the outer periphery 18 and four mm over the inner periphery 20. Alternatively, the elastomer 22 might cover the entire bottom side 16 of the metal member 12.

In some embodiments, especially where the seal is not placed in a bore having a shaft, the insert may not comprise the central opening. In those embodiments, only the outer periphery is provided with the molded elastomer. In some further embodiments comprising the inner periphery, elastomer is optionally omitted from the inner periphery. In those cases, the centrifugal forces will force the fluids to the outer periphery of the seal and little or no sealing is necessary in the center area around the shaft.

The elastomer 22 extends from the bottom side 16 to the top side 14 of the metal member 12 and covers the entire inner and/or outer peripheries, depending upon the desired sealing properties. In adhesive bonded piston seals known in the art, the thickness of the elastomer over the peripheries is usually in the range of 0.22 mm to about 1.34 mm. In application, the distance between the elastomer and the wall of the shaft 30 or bore is designed to be 0.25 mm to about 0.4 mm. Hence, the total sealing gap between the metal member 12 and the sealing surface (the shaft 30 for the outer periphery 18 and the bore for the inner periphery 20) is known to be 0.49 mm to 1.74 mm. In comparison, the sealing gap for cast piston seals is ordinarily 0.2 mm. The larger sealing gap in bonded piston seals is the result of several factors. First, a larger sealing gap permits greater variation in the manufacturing process. That is, a piston seal with a larger elastomer thickness and clearance with the sealing surface will tolerate imprecision in the placement of the metal member in the mold by ensuring sufficient elastomer on either side. Second, a thinner elastomer mold, it was believed, would not permit adequate flow of elastomer so that certain areas around the metal member might not be adequately covered with elastomer. On the other hand, if the sealing gap were too wide and no adhesive were used, the elastomer would extrude through the sealing gap under pressure.

Contrary to expectations, the present invention achieves a smaller sealing gap without the use of adhesives. In the preferred embodiments, the thickness of the elastomer 22 over the peripheries is less than about 0.3 mm, and the clearance between the elastomer 22 and the sealing surface is less than about 0.2 mm. In the preferred embodiment, the piston seal 10 is designed to have an elastomer thickness 28 of 0.3 mm and clearance between the elastomer and the sealing surface 29 of approximately 0.11 mm for a total sealing gap of 0.41 mm. In practice, according to the method of manufacture described below, the actual sealing gap is reduced even further.

FIG. 2 depicts a piston seal 10 according to an embodiment of the invention in the area around the outer periphery. It should be understood that the features of the piston seal 10 in the area of the outer periphery 18 are identical to the features of the piston seal 10 in the area of the inner periphery 20 where piston insert is provided with a central opening and an elastomer is molded thereover. The elastomer 22 comprises an outer lip 24 (and accordingly, an inner lip 26 at the inner periphery 20) extending upwardly and radially away from the insert 112 (outwardly with respect to the outer periphery or inwardly with respect to the inner periphery) towards the bore wall 30 (or shaft wall for the inner lip 26).

FIG. 3 depicts a further embodiment of the invention. In this embodiment, the piston seal 110 comprises an elastomer 122 molded without adhesive over the outer periphery 118 of the piston seal insert 112. The elastomer 122 has an outwardly and upwardly extending lip 124 extending away from the insert 124. The elastomer 122 further comprises a shoulder 140 wherein the elastomer immediately adjacent the outer periphery 118 is recessed relative to the lip 124. The provision of the shoulder 140 may reduce some wear and tear on the portion of the elastomer 142 at the corner 144 of the insert where the elastomer 122 is the thinnest. That is, the shoulder 140 absorbs more of the frictional stress on the elastomer 122 caused by the installation of the seal 110.

The features and advantages of preferred embodiments of the present invention are achieved through the use of the manufacturing method, embodiments of which are described herein. The methods of the present invention achieve a molded piston seal wherein an elastomer is molded to a piston seal insert without adhesive, permitting a narrower, and hence more reliable, sealing gap. According to embodiments of the present method, an insert is provided. In the preferred embodiments, the insert is a metal member created through steel stamping. Other production methods may include metal spinning or molding a plastic.

The piston seal insert is then pre-heated and placed into a mold. Pre-heating of the insert has several advantages not attainable with an adhesive-bonded piston seal. Pre-heating the insert lessens the degree to which the insert acts as a heat sink during the heating step necessary to cure the elastomer. Accordingly, less heat is required to cure the elastomer, leading to increased cost savings from the reduced energy consumption and production time. The advantages of pre-heating, however, are less compatible with an adhesive-bonded piston seal since adhesive applied to a heated surface, especially a metal surface, might overheat the adhesive, reducing effectiveness of the bond.

In alternative embodiments, the piston seal insert may be thin enough that pre-heating is unnecessary.

According to the next step, the elastomer is added to the mold to cover at least the inner or outer peripheries of the piston seal insert. Again, the piston seal insert may or may not comprise an inner periphery, and if it does, it may or may not be overmolded with an elastomer. Typically, the mold is made of steel or stainless steel, and a hydraulic press is used to compress the mold. In alternative embodiments, the elastomer covers additional areas, such as the bottom side of the insert. Typically, elastomer is added to the mold via injection, compression or transfer molding.

After the elastomer has been added to the mold, the elastomer is molded to the piston seal insert. This step can be accomplished in several ways, including without limitation, compression molding, injection molding and transfer molding.

According to another advantageous embodiment, the method further comprises the step of coining the insert after the elastomer is added to the mold. Coining refers to the process whereby the insert is permanently deformed to prevent excess flow of the rubber beyond the cavity of the mold. In the preferred embodiment, the mold comprises two half-round R.3 coining rings (i.e., having a radius of 0.3 mm). The coining rings may comprise pointed rings or other radii, although half-round R.3 coining rings are the preferred embodiment. As the mold is compressed, the coining rings press into the insert on the top and bottom sides of the insert in areas adjacent the peripheries. The coining rings have several advantageous effects. First, they prevent the elastomer from spilling over the piston seal insert into undesirable areas. Second, the coining causes the insert to spread radially inside the mold. As the insert spreads, a tighter fit is created between the insert and the elastomer. Moreover, the elastomer thickness at the periphery is reduced while the outer diameter of the insert is increased. The result further reduces the sealing gap between the insert and the shaft wall or bore, achieving an even better and more reliable seal.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

1. A piston seal comprising:
a piston seal insert having a top side, a bottom side, an outer substantially circular periphery and a central opening defined by an inner substantially circular periphery;
an elastomer molded over at least the inner periphery or the outer periphery and at least partially wrapped around the top side and bottom side; and
wherein the molded elastomer comprises a lip portion extending upwardly and radially away from the piston seal insert;
wherein the elastomer is loosely secured to the piston seal insert without adhesive.

2. The piston seal of claim 1 wherein the elastomer is molded over the outer periphery.

3. The piston seal of claim 2 wherein the thickness of the elastomer over the outer periphery is less than about 0.5 mm.

4. The piston seal of claim 2 wherein the thickness of the elastomer over the outer periphery is about 0.3 mm.

5. The piston seal of claim 1 wherein the elastomer is molded to the piston seal insert by compression molding.

6. The piston seal of claim 1 wherein the piston seal is placed in a bore having a shaft therein with the shaft through the central opening.

7. The piston seal of claim 2 wherein the piston seal is placed in a bore having a shaft therein with the shaft through the central opening.

8. The piston seal of claim 7 wherein the distance between a wall of the shaft and an outer edge of the elastomer molded over the outer periphery is less than about 0.25 mm.

9. The piston seal of claim 7 wherein the distance between a wall of the shaft and an outer edge of the elastomer molded over the outer periphery is about 0.11 mm.

10. The piston seal of claim 9 wherein the thickness of the elastomer over the outer periphery is less than about 0.5 mm.

11. The piston seal of claim 1 wherein the elastomer is molded over the inner periphery and the outer periphery.

12. The piston seal of claim 1 wherein a portion of the elastomer immediately adjacent the periphery over which the elastomer is molded is recessed relative to the lip portion.

13. (currently amended) A method for producing a piston seal comprising:
placing a piston seal insert having a top side, a bottom side, an outer substantially circular periphery and a central opening defined by an inner substantially circular periphery into a mold;
adding an elastomer to the mold to cover at least the outer periphery or the inner periphery of the insert; and
molding the elastomer around at least the outer periphery or the inner periphery of the insert to wrap at least partially around the top side and bottom side, wherein the elastomer is loosely secured to the insert without adhesive.

14. The method of claim 13 further comprising pre-heating the insert.

15. The method of claim 13 further comprising coining the piston seal.

16. The method of claim 15 wherein the coining is accomplished through the use of coining rings.

17. The method of claim 13 wherein the step for molding the elastomer around the insert comprises compression molding.

18. The method of claim 13 wherein the step for molding the elastomer around the insert comprises transfer molding.

19. The method of claim 13 wherein the step for molding the elastomer around the insert comprises injection molding.

20. The method of claim 13 further comprising expanding the insert within the elastomer.

21. (currently amended) A piston seal comprising:
a piston seal insert having a top side, a bottom side, and an outer substantially circular periphery;
an elastomer molded over the outer periphery and at least partially wrapped around the top side and bottom side;
wherein the molded elastomer comprises a lip portion extending upwardly and radially away from the piston seal insert; and
wherein the elastomer is loosely secured to the insert without adhesive.

22. The piston seal of claim 21 wherein the thickness of the elastomer over the outer periphery is less than about 0.5 mm.

23. The piston seal of claim 21 wherein the thickness of the elastomer over the outer periphery is about 0.3 mm.

24. The piston seal of claim 21 wherein the elastomer is molded to the piston seal insert by compression molding.

25. The piston seal of claim 21 wherein a portion of the elastomer immediately adjacent the outer periphery is recessed relative to the lip portion.

26. A method for producing a piston seal comprising:
placing a piston seal insert having a top side, a bottom side, and an outer substantially circular periphery into a mold;
adding an elastomer to the mold to cover the outer periphery of the insert and at least partially wrap around the top side and the bottom side; and
molding the elastomer around the outer periphery of the insert, #wherein the elastomer is loosely secured to the insert without adhesive.

27. The method of claim 26 further comprising pre-heating the insert.

28. The method of claim 26 further comprising coining the piston seal.

29. The method of claim 28 wherein the coining is accomplished through the use of coining rings.

30. The method of claim 26 wherein the step for molding the elastomer around the insert comprises compression molding.

31. The method of claim 26 wherein the step for molding the elastomer around the insert comprises transfer molding.

32. The method of claim 26 wherein the step for molding the elastomer around the insert comprises injection molding.

33. The method of claim 26 further comprising expanding the insert within the elastomer.
